(19) United States
(12) Patent Application Publication
(10) Pub. No.: US 2026/0033471 A1
(43) Pub. Date: Feb. 5, 2026

(54) FISHING LURE AND METHOD FOR PRODUCING SAME

(71) Applicant: CAPT’N GREENFIN AG, Bern (CH)

(72) Inventor: Jonas URWYLER, Murten (CH)

(73) Assignee: CAPT’N GREENFIN AG, Bern (CH)

(21) Appl. No.: 18/997,449

(22) PCT Filed: Jun. 14, 2023
(86) PCT No.: PCT/IB2023/056133

§ 371 Date: Jan. 21, 2025

(30) Foreign Application Priority Data
Jul. 22, 2022 (EP) 22186387.1

(51) Int. Cl. A01K 85/00

(52) U.S. Cl. CPC A01K 85/1897; A01K 85/1811

(57) ABSTRACT

A fishing lure has a composition of substances which has a protein, a polysaccharide, a polyhydric alcohol and water, wherein the weight percentages of protein are between 15 wt % and 35 wt. %, of polysaccharide between 0.5 wt % and 3 wt %, of polyhydric alcohol between 35 wt % and 75 wt %, and of water between 15 wt % and 35 wt % in the composition of substances. Furthermore, a fabrication process for a fishing lure which degenerates in water and which is also non-toxic to organisms living in water, such as fish.

### TECHNICAL FIELD

The invention relates to a fishing lure with a body made of a composition of substances which degenerates when immersed in water. The composition of substances is non-toxic, i.e. non-toxic to fish and other aquatic organisms. Furthermore, the invention relates to a method of manufacturing the fishing lure. The manufacturing process is suitable for producing a homogeneous composition of substances for a fishing lure, or more precisely its body, which has a high tensile strength and at the same time good decomposability in water.

### STATE OF THE ART

According to various nature and environmental protection agencies, water pollution caused by plastics is causative of the extinction of species worldwide. This not only affects microorganisms living in the water, but also fish populations which serve as a food source for mankind.

According to the Global Fund for Nature Foundation, between 4.8 and 12.7 million tonnes of poorly degradable plastics end up in the world's oceans every year. A large proportion of this is discharged by the commercial fishing industry, which continues to use poorly degradable plastic material for nets, bait and traps, the list not being exhaustive.

If the plastic becomes brittle over time and is broken down by the waves, it enters the digestive tract of fish in the form of microplastic material, commonly causing the death of the fish as a result of microplastics stored in the digestive tract.

Fishing lures available on the market today, be it for recreational or commercial fishing, are usually designed in the shape and form of a prey animal, such as a small fish, insect or worm. These fishing lures are produced industrially using machines and are referred to as artificial lures in the jargon.

Common fishing lures have a body which may comprise a mixture of different elastomers, which are usually petroleum-based. Fishing hooks can be inserted into this body to attach the fishing lure, with the fishing hook and attached fishing lure often being attached to a main line or line via a leader.

The fishing lure, together with the embedded fishing hook, is swallowed by a fish, such as a predatory fish, whereby the fishing hook gets caught in the fish's mouth by a jerky movement (strike) on the fishing rod of the fisherman.

The body imitates a prey animal through its shape and movement in the water, which attracts fish and encourages them to bite. Attractants are often added to commercially available fishing lures to make them more appealing to fish and thus increase the likelihood of a bite.

However, fishing lure used for fishing can also be used to attract, for example, crustaceans in fish traps, provided that the baits contain the appropriate attractants. In this case, there is no need to insert a fishing hook, as the fishing lure is used solely to attract the predator.

The artificially produced compositions of substances used for flexible artificial bait often contain plasticisers that end up in the water. These plasticisers can have a toxic effect on organisms living in the water. For example, these plasticisers can accumulate in the tissue of fish, rendering them inedible for humans.

It is also common for the artificial bait to become detached from the fishing hook and to be swallowed by a fish without the fish being landed. The fish subsequently dies as a result of swallowing the lure, since the lure blocks the fish's digestive tract. Today's artificial lures do not dissolve in water or in the digestive tract of fish.

The fishing lure may detach from the fishing hook during the fight (i.e. reeling in the catch) and is not swallowed by a fish, leading to a further release of hard-to-decompose plastic into the water, which is of course not in the interest of fishermen.

It is therefore a task of the invention to provide a fishing lure and a method for producing such fishing lure, which eliminates at least some of the disadvantages of the fishing lures and their production methods known from the prior art.

### DESCRIPTION OF THE INVENTION

The invention relates to a fishing lure comprising a composition of substances including a protein, a polysaccharide, a polyhydric alcohol and water, wherein the amount of protein is between 15 and 35 wt. %, the amount of polysaccharide is between 0.5 and 3 wt. %, the amount of polyhydric alcohol is between 35 and 75 wt. % and the amount of water is between 15 and 35 wt. % in the composition of substances.

The term “fishing lure” is to be understood as a collective term that refers both to a fishing lure for fishing with a line or line and to a bait for attracting other fishable creatures living in bodies of water.

Preferably, the specified weight percentages refer to the weight percentages of the individual substances used in the production of the composition. Alternatively, the stated weight percentages can refer to the weight percentages of the individual substances used in the end product. The substances used for the composition of substances are preferably obtained from renewable raw materials. These may be raw materials of plant and/or animal origin.

Plant-based proteins may for example be obtained from beans, nuts or cereals. Animal-based proteins may be obtained from eggs, meat and/or other animal components. This is advantageous as there is no need for petroleum-based raw materials, and is therefore particularly resource-efficient.

The polyhydric alcohol may be in the form of a bivalent or trivalent alcohol, which is obtained from renewable raw materials. Polyhydric alcohols usually have a toxic effect on organisms in their pure form. This toxicity is at least reduced or completely eliminated by mixing with other substances, such as substances from the composition of substances described here. The composition of substances is therefore non-toxic for organisms living in water.

The polysaccharide used for the fishing lure can also be based on renewable raw materials. Possible raw material sources for this include, but are not limited to, cereals, potatoes, but also eukaryotic organisms such as algae.

The proposed composition has the advantage that the fishing lure is flexible when used in the air, while still having a high strength, in particular tear resistance, such that a hook for example can be inserted into it.

When the fishing lure is placed in water, the flexibility and tensile strength are retained for a certain period of time, resulting in a secure attachment of the fishing lure to the fishing hook.

Nevertheless, the fishing lure swells due to the incorporation of water into the composition of substances, so that it disintegrates or is completely dissolved when in contact with water over a prolonged period in time. Surprisingly, this effect is achieved by the specified weight percentages of polyhydric alcohol and water. Among other characteristics, the decomposability in water can be controlled by this weight percentages. A fishing lure containing the composition of substances with the specified weight percentages is therefore a real alternative to plastic baits.

Whether the fishing lure is used in fresh or salt water is irrelevant. The fishing lure can therefore be used for fishing in all waters.

If the fishing lure detaches from the fishing hook during fishing, the composition of substances breaks down into its components and no additional waste that survives in the water over a prolonged period of time is released. This also means that when a fish swallows the bait, it is metabolized in the digestive tract instead of dying. The acid present in the fish's digestive tract decomposes the fishing lure in a shorter period of time, allowing the fish to continue to feed.

Furthermore, the inventors found that by combining a protein with a polysaccharide in the specified weight percentage, a surprisingly high melting point of the fishing lure can be achieved. This is particularly advantageous on warm days and in bright sunlight, as the composition of substances does not melt, or at least only melts slightly, such that it is still possible to insert a fishing hook into the fishing lure or into the body of the fishing lure.

The fishing lure, especially its body, may have the shape of a prey animal.

Preferably, the composition of substances is free of plasticizers, which are typically used industrially for plastics and are listed in the ISO 1043-3:2016 standard. This results in good environmental compatibility of the fishing lure.

It is also possible that other substances, such as colour pigments, flavourings and/or attractants, are added to the composition of substances in order to increase the attractiveness for a fish to bite.

In one embodiment of the fishing lure according to the invention, the protein may be in the form of gelatin. The gelatin may be bone gelatin of animal origin.

The gelatine may be present as medium-bloom or high-bloom gelatine, whereby a high-bloom gelatine results in a higher strength of the composition of substances due to a better gelling capacity and is therefore preferred.

In a further embodiment of the fishing lure according to the invention, the polysaccharide may be present in the form of agar, starch or alginate, or a composition of agar, starch and/or alginate. These substances are readily available from renewable raw materials and are therefore preferred. Preferably, however, the composition of substances according to the invention comprises only agar as polysaccharide.

In a further embodiment of the fishing lure according to the invention, the polyhydric alcohol may be present in the form of glycerol.

Glycerol is non-toxic to aquatic organisms and its use is therefore favoured. In addition, glycerol can be produced from plant or animal raw materials using established processes.

In a further embodiment of the fishing lure according to the invention, the composition of substances may contain at least one preservative in the form of an antimicrobial substance.

Preferably, the antimicrobial substance is a vegetable tanning agent that is easily degradable in water. The vegetable tanning agent can be tannin, which can be produced from grape components.

Alternatively or additionally, the antimicrobial substance is an aluminium salt, preferably aluminium sodium sulphate. In addition to its preservative effect, tha antimicrobial substance provide the further advantage that they can regulate the acidity in the composition of substances. As a result, the flexibility and strength of the composition of substances may be optimised.

Preferably, the proportion of the at least one preservative in the composition of substances is between 0.05 and 0.5% by weight. It is also possible to use a mixture of the vegetable tanning agent and the aluminium salt, which, however, preferably does not exceed the above-mentioned weight percentages (when combined).

In a further embodiment of the fishing lure according to the invention, the melting point of the composition of substances may be above 55° C., preferably above 65° C.

This is achieved in particular by the different weight percentages of the individual substances in the composition, as defined above. Especially when the fishing lure is used in warm waters, where the water temperature can be up to 28° C. or higher, such a high melting point ensures, among other things, that the composition of substances retains a high tensile strength. Such a high melting point also prevents the composition of substances from decomposing if it is exposed to the sun for a longer period of time.

In a further embodiment of the fishing lure according to this invention, the fishing lure may comprise a body containing the composition of substances, wherein the body has a volume, wherein the volume of the body increases by 25% if the fishing lure is fully immersed in water, such as salt water or fresh water, for a period of 30 minutes.

The increase in volume may refer to an initial volume of the body, for example directly when the fishing lure is removed from a package. The water may have a temperature of 20° C. Deviating water temperatures cause the fishing lure or its composition of substances to swell faster (higher temperature) or slower (lower temperature).

In a further embodiment of the fishing lure according to this invention, the fishing lure may comprise an elongated body containing the composition of substances, wherein the elongated body has an initial length, wherein the elongated body may be elongated by at least 300% or by at least 400% relative to the initial length without tearing due to the elongation.

The initial length may refer to the length of the elongated body when it is removed from a package. The elongated body may have a temperature of 20° C. during elongation. Deviating temperatures mean that the elongated body may be elongated less (at a lower temperature) or more (at a higher temperature) until it tears.

The linear expansion is an important parameter of the fishing lure. Among other things, it determines how stretchy the fishing lure is and therefore how easy it is to insert a fishing hook into it. This parameter can also be used to determine how much force a biting fish would have to exert to tear the bait off a fishing hook.

In a further embodiment of the fishing lure according to the invention, the fishing lure may comprise a body containing the composition of substances, wherein the body dissolves completely when the body is fully immersed in water for a period of from 24 hours to 240 hours.

Alternatively, and particularly preferably, the body may dissolve in water over a period of 24 hours to 96 hours. The water may be fresh water or salt water and have a temperature of 20° C.

Varying water temperatures cause the fishing lure or its composition of substances to dissolve more quickly (at a higher temperature) or more slowly (at a lower temperature).

The decomposability of the fishing lure is another important parameter of the fishing lure that can be varied by varying the weight percentages of the individual substances in the composition of substances described above. Depending on the intended use, e.g. for use as fishing lure for angling or as bait in a fish trap, the decomposability or degenerability in the water can be adjusted.

In a further embodiment of the fishing lure according to the invention, the body containing the composition of substances may comprise a core and a shell enclosing the core, wherein the shell has a higher strength compared to the core. Furthermore, the shell may have a higher temperature resistance, i.e. a higher melting point, compared to the core. The melting temperature of the shell can exceed 70° C., preferably 80° C., particularly preferably 90° C., so that even at high temperatures, in particular at high solar radiation, the fishing lure has a strength to enable the insertion of a hook into the body and to ensure fishability by means of fishing lure. However, despite the improved temperature resistance of the shell, the body can be digested by the fish and continues to degenerate in the water. The core, however, largely retains its properties, in particular its temperature resistance (melting point above 55° C., preferably above 65° C.), as indicated in the aforementioned embodiments, since the cross-linking has no effect on it.

In a further embodiment of the fishing lure according to the invention, the shell may be obtainable by cross-linking the protein of the composition of substances by means of at least one enzyme, wherein “obtainable” means that the shell is or may be produced by cross-linking the protein by means of an enzyme. Here, the body can be immersed in an enzyme bath, a solution or a dispersion containing the at least one enzyme and a liquid, such as water, for a certain period of time. The solution or dispersion penetrates at least partially into the body and the at least one enzyme cross-links the protein. The shell may be formed by this cross-linking, whereby the core preferably retains its material properties, such as melting point, strength, etc., as the solution or dispersion does not penetrate into the interior of the body, provided that the time period is chosen appropriately short. The at least one enzyme may be transglutaminase, which enables rapid cross-linking of the protein and is easy to handle and readily available. The enzyme transglutaminase may be obtained from the spore-forming bacterial species Streptomyces mobaraensis by means of fermentation and subsequent drying, it may be used in predominantly non-medical applications. Industrially, the enzyme may also be referred to as a “technical enzyme”. Enzymes other than the one mentioned may be used to influence or produce other material properties according to the intended use. Enzymes such as papain, bromelain and/or ficaine may be used to produce a shell that is less firm in order to improve the swallowability of the fishing lure.

In a further embodiment of the fishing lure according to this invention, the composition of substances may contain a cross-linking enzyme. By adding the enzyme to the composition of substances, the cross-linking may already occur during the production of the composition of substances, which leads to increased material and temperature resistance. As a result, different from the aforementioned possibility of producing a shell, the entire composition of substances is provided with the mentioned advantages. Moreover, the production is also simplified, as the step of insertion is no longer necessary. The at least one enzyme may be transglutaminase. A fishing lure (i.e. body) may then be produced from the composition of substances, which exceeds a melting temperature of 70° C., preferably 80° C., particularly preferably 90° C., so that the fishing lure has a high strength even at high temperatures, particularly when exposed to high levels of sun radiation.

It is generally noteworthy, however, that the basic material properties of the composition of substances may be further improved by treating the composition with the enzyme or by adding the enzyme to the composition of substances, such that a combined beneficial effect, building on the good material properties of the underlying composition of substances, may be observed.

In a further embodiment of the fishing lure according to this invention, the composition of substances may be shown to be non-toxic to fish using a method according to OECD 249:2021 or ISO 21115:2019, i.e. the composition of substances is non-toxic to fish and further does not contain any substances that are toxic to fish. It can therefore be assumed that it is also non-toxic to other organisms found in water. The year after the colon of the two cited standards indicates the year of issue of the respective standard. Preferably, these editions of these methods from the years in question are used as the basis for testing fish toxicity.

The detection or indication method according to the standards mentioned above is also known as the “fish cell line test” and is used to assess the acute fish toxicity of substances and/or compositions of substances.

The invention also relates to a manufacturing process for a fishing lure which degenerates in water, as described above in one embodiment or the combination of several embodiments, comprising the following process steps:
preparing a composition of substances comprising at least one protein, at least one polysaccharide, at least one polyhydric alcohol and water;
heating the composition of substances to a temperature within a first temperature range and maintaining the temperature within the first temperature range over a first period of time to homogenise the composition of substances, preferably using a stirring means;
cooling the composition to a temperature within a second temperature range;
storing the composition at a temperature within the second temperature range for a second period of time;
heating the composition to a temperature within the first temperature range once or several times;
cooling the composition to a temperature within the second temperature range.

The process steps may be carried out in the previously defined sequence. Terms such as “after”, “before”, “following”, etc. may (but do not necessarily have to) define temporal sequences and/or sequences of the process steps.

The process advantageously results in a fishing lure with a homogeneous composition of substances. In this case, homogeneous means that the individual substances are evenly dissolved in the composition of substances without the individual substances being visible to the naked eye.

The composition of substances may have a high tensile strength, with simultaneously good decomposability in water, and may advantageously be used for the manufacture of the fishing lure, or the body thereof. The composition of substances obtainable by the manufacturing method may comprise the composition of substances as described in relation to the fishing lure and may therefore have all the advantages and features mentioned above. Preferably, however, the composition of substances for the manufacturing process is free of the at least one enzyme, unless otherwise described.

The penultimate process feature, in which the composition is heated one or more times to a temperature within the first temperature range, is important for production, but not exclusively so.

This process step may include an intermediate step in which the composition is brought to a temperature within the second temperature range and stored for a further period of time.

The thermal cycles, i.e. alternating heating and cooling, homogenise the composition and give it its typical material properties, such as excellent tensile strength and good, i.e. rapid, decomposability in water.

In one embodiment of the manufacturing process according to this invention, the first temperature range may be between 55° C. and 200° C. Preferably, the temperature range is between 70° C. and 100° C. The lower temperature threshold of the preferred temperature range may be selected such that the composition of substances just begins to melt and may thus approximately correspond to the melting point of the fishing lure. The upper temperature threshold of the preferred temperature range may be selected so that the protein used, preferably in the form of gelatine, does not lose its gelling properties when heated.

When producing larger quantities of the composition of substances, heating above the upper temperature threshold leads to increased energy consumption, which is not desirable in the mass production of the fishing lure, in particular the substance mixture, unless this results in a material advantage.

Additionally or alternatively, the second temperature range may be between 10° C. and 40° C.

Furthermore, the first time period may be between 60 minutes and 600 minutes. Additionally or alternatively, the second period may be between 20 hours and 10 days.

In a further embodiment of the production process according to this invention, the process may comprise, after the step of heating the composition of substances once or several times and after cooling the composition of substances to the temperature within the second temperature range, the step of:
introducing at least one cross-linking enzyme, preferably transglutaminase, into the composition of substances using a stirring agent.

As described above, this can achieve better linking (i.e. cross-linking) of the protein, which can lead to higher strength with improved temperature stability at the same time. The stirring means, for example a dough hook, can be used to distribute the at least one enzyme homogeneously in the composition of substances. It is essential that the cross-linking enzyme is only introduced when the composition of substances has a temperature of less than 50° C., preferably less than 40° C., as otherwise there is a risk of inactivating the enzyme activity.

In a further embodiment of the production process according to this invention, the process may comprise the following steps after the introduction of the cross-linking enzyme:
storing the composition of substances within the second temperature range for a duration within the first time period;
heating the composition of substances to a temperature within a temperature range between 65° C. and 100° C. and maintaining the temperature for a duration within the first time period;
cooling to a temperature within the second temperature range.

Storing the enzyme-containing composition cross-links the protein. Heating the stored and cross-linked composition of substances can optionally be used to inactivate the enzyme activity and then adjust the desired substance or material properties of the composition of substances before the protein in the composition of substances is fully cross-linked.

In a further embodiment of the manufacturing method according to this invention, the method may comprise the steps of:
producing a body comprising the composition of substances; and
packaging the body using a package which is sealed airtight, preferably gas-tight. The airtight or gas-tight packaging can protect the body (i.e. the fishing lure) from swelling, as contact with moisture can be prevented.

In a further embodiment of the method of manufacture according to the invention, the method may comprise the steps of:
producing a body comprising the composition of substances;
immersing the body in a mixture containing at least one cross-linking enzyme, preferably transglutaminase, for a period of time between 30 minutes and 120 minutes;

After removal from the mixture:
storing the body, preferably in air, at a temperature within the second temperature range and for a duration within the second time period.

The produced body can be immersed or bathed in the mixture for a certain period of time directly after production or after a short storage period, which may correspond to a duration within the second period. As explained above, the duration of the immersion or bathing determines how far the mixture penetrates into the body and leads to the formation of the shell. During immersion or bathing, the body swells due to the incorporation of the components of the mixture, whereby subsequent drying of the body, preferably in air at room temperature, may in turn lead to a reduction in size, as components can evaporate or otherwise escape from the body. After immersion or bathing, the body may also be heated to the temperature described above for the composition of substances in order to prevent excessive cross-linking during the formation of the shell. This would also have the advantage that the body dries more quickly and returns to its original size (i.e. the size before immersion or bathing). The mixture may comprise water in which the said enzyme is dissolved. If other ingredients are added to the mixture, the mixture may also be thick or syrupy. After the body has been stored, it may be packaged using a packaging material which is sealed airtight, preferably gas-tight.

In further, not claimed, embodiments of the manufacturing method, the method may comprise further process steps, such as adding further substances, such as attractants to the composition of substances ces, or removing air inclusions during the production of the composition of substances.

In a further aspect, the use of at least one enzyme, preferably transglutaminase, for the preparation of the fishing lure according to any of the aforementioned aspects and/or embodiments (including combinations thereof) is disclosed.

### BRIEF DESCRIPTION OF THE FIGURES

The invention is explained in more detail with reference to the attached figures, which show:

FIG. 1 a fishing lure according to the invention;

FIG. 2 a mould for producing a fishing lure according to the invention.

### DETAILED DESCRIPTION OF THE INVENTION

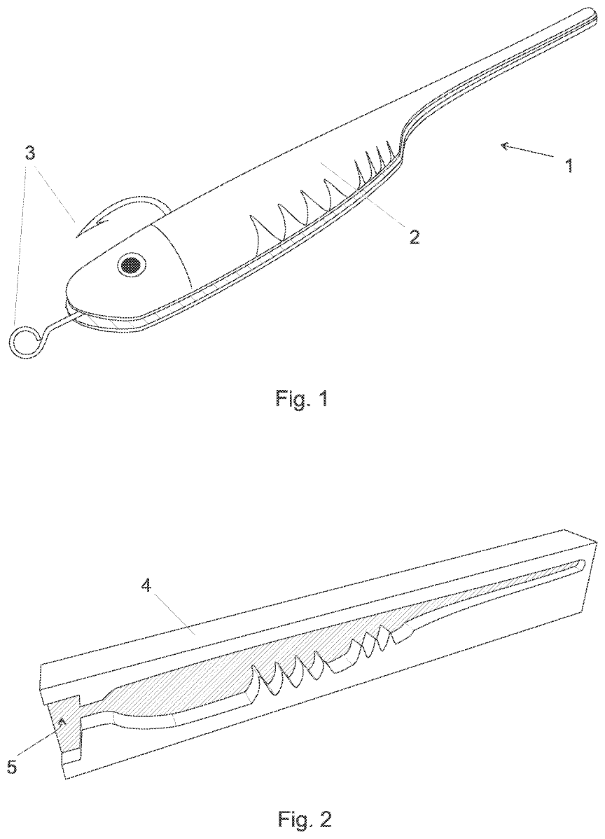

FIG. 1 schematically shows a first embodiment of the invention, in particular of a fishing lure 1 according to the invention.

In this embodiment, the fishing lure 1 consists of a body 2 in which a fishing hook 3 is embedded. The fishing lure 1 has the shape of a small prey fish. The illustration is not to scale.

This fishing hook 3 could already be inserted into the body 2 when the fishing lure is sold. Preferably, however, this fishing hook is inserted into the body 2 by a fisherman so that the size of the fishing hook 3 can be adapted to the circumstances, primarily to the body of water and the target fish.

In this example, the fishing hook 3 has a curved end with a barb, whereby the barb would get caught in the mouth of a fish when it bites. A second straight end has an eyelet for attachment to a leader (not shown).

In this first embodiment example, the body 2 of the fishing lure 1 comprises a composition containing the following substances and in the following weight percentages:

| Fabric | Weight percentage | |
|---|---|---|
| Gelatine with 250 bloom | 20 | wt % |
| Agar | 1 | wt % |
| Glycerine | 54.75 | wt % |
| Tannin | 0.25 | wt % |
| Water | 24 | wt % |

Tests with this composition of substances have shown that the composition, or the body produced from it, has a melting point of 58° C. This is sufficiently high for the fishing lure to be fishable in all waters and to have the typical advantages described above.

Furthermore, experiments in which the body was permanently placed in fresh water at a water temperature of 20° C. have shown that the volume (in relation to the initial volume) of the body increases by 28% within 30 minutes, with the body completely decomposing within 240 hours.

Previous tests carried out on the body and at a temperature of 20° C. also showed that the body could be elongated by 310% (in relation to the initial length) without tearing. After elongation, the body almost completely returned to its initial length.

In a further test, and with reference to an embodiment example not shown, in which the fishing lure was in the form of a worm, a composition containing the following substances and in the following proportions by weight was tested:

| Fabric | Weight percentage | |
|---|---|---|
| Gelatine with 200 bloom | 20 | wt % |
| Agar | 3 | wt % |
| Glycerine | 60 | wt % |
| Water | 17 | wt % |

The composition of substances had a higher melting temperature compared to the previous example. The melting temperature was 66° C.

The body decomposed somewhat faster in this test and under comparable test conditions, namely within 200 hours.

Under comparable test conditions, the body could be elongated to 410% (in relation to the initial length) without tearing.

In a third test, and in relation to an example embodiment not shown, in which the fishing lure was in the form of a beetle, a composition containing the following substances and in the following proportions by weight was tested:

| Fabric | Weight percentage | |
|---|---|---|
| Gelatine with 200 bloom | 21 | wt % |
| Agar | 3 | wt % |
| Glycerine | 57 | wt % |
| Water | 18 | wt % |
| Transglutaminase mixture | 1 | wt % |

In addition to the enzyme transglutaminase, the transglutaminase mixture also contained the excipient maltodextrin, which served as a carrier for the transglutaminase. The transglutaminase exhibited an activity of 125 μ/g, with a concentration of approx. 1% by weight in the transglutaminase mixture. Further tests have shown that ready-to-use transglutaminase mixtures with a similar composition, such as Moo Gloo TI Transglutaminase from Modernist Pantry or Transglutaminase Bindly RM from BDF Natural Ingredients, can be used as an alternative. The ready-to-use transglutaminase mixtures were also used at a weight percentage of 1 wt % in the composition of substances of the fishing lure.

The composition of substances had a higher melting temperature compared to the previous embodiments. The melting temperature was 91° C.

The body decomposed somewhat more slowly in this test and under comparable test conditions, namely within 260 hours.

Under comparable test conditions, the body could be elongated to 350% (in relation to the initial length) without tearing.

FIG. 2 schematically shows one half 4 of a mould assembly (not shown) for producing the body 2 according to the first embodiment of the invention.

The mould assembly is joined together from two halves 4. The composition of substances, with the composition as described in the first embodiment example shown or the second embodiment example, which is not shown, is injected into the mould assembly through an opening 5. The composition of substances hardens in the mould assembly for several hours before the mould assembly is separated into its two halves 4. Initially, i.e. when injected into the mould assembly, the composition of substances has a temperature that is above the melting point of the composition. During the aforementioned curing period, the temperature of the composition of substances falls below its melting point, causing the composition of substances to cure in the mould assembly.

Of course, the composition of substances can also be cured in a shorter time. The mould assembly can be placed in a cooling device to bring the composition below the melting temperature in a shorter time. However, this could result in material disadvantages, as the molecular chains have less time to form complex bonds. The result could be a composition of substances that has a lower tensile strength.

Previously, the composition of substances was prepared using a suitable manufacturing process as described in the present overall disclosure.

A mixture, or composition of substances, was first prepared as described in the first embodiment. The composition of substances was then heated to a temperature of 95° C. while stirring with a stirrer and kept at this temperature for 80 minutes.

The composition of substances was then allowed to cool to a temperature of 25° C. and stored at this temperature for a period of 24 hours. After this period, the composition of substances was heated again with stirring to a temperature of 95° C. and immediately cooled back down to a temperature of 25° C.

The inventors have found that this last step results in a particularly homogeneous and tear-resistant composition of substances. The composition of substances was then injected into the mould assembly and, as already described, left in the mould assembly before the body 2 was moulded.

Further, after demoulding, the body 2 was further stored in air, at room temperature, for a period of 24 hours to further solidify the material before the body 2 was placed in a viscous mixture of water and a transglutaminase mixture containing the ingredients from the third experiment in the amounts indicated. The weight proportions of the viscous mixture were 75 wt % water and 25 wt % transglutaminase mixture. Body 2 remained in the viscous mixture for 45 minutes at room temperature (approx. 22° C.). After removal and subsequent drying for 48 hours in air at room temperature, tests were carried out again.

The body 2 (in particular the shell) produced from the composition of substances of the first embodiment example had a melting point of 101° C. Surprisingly, the other properties, such as decomposability in water and elongation, did not show any significant change. In this embodiment, the melting point refers to the shell of body 2, obtained by placing it in the viscous composition and then drying it in air. The core of the body 2 had a lower melting point, which was at the temperature mentioned in the first embodiment example of the invention. A person skilled in the art might now ask whether it is practicable to insert a fishing hook into the body 2 when the core is in a molten state. The inventor would answer this in the affirmative, because the shell is highly flexible so that it firmly encloses and seals the fishing hook to prevent the leakage of a possibly liquid core. As soon as the fishing lure is placed in water, the core solidifies again, further preventing leakage.

However, the embodiments as disclosed above are not limited to the specifically mentioned values and parameters such as weight percentages, temperatures or time periods. All values and parameters, as can be seen from the overall disclosure, could be varied in order to obtain a fishing lure which has the described advantages over currently available fishing lures. The stated weight percentages (wt %) for the non-liquid substances may refer to the weight percentage in dry matter.

1-20. (canceled)

21. A fishing lure containing a composition of substances which comprises a protein, a polysaccharide, a polyhydric alcohol and water, wherein the weight percentages of protein are between 15 wt % and 35 wt %, of polysaccharide between 0.5 wt % and 3 wt %, of polyhydric alcohol between 35 wt % and 75 wt %, and of water between 15 wt % and 35 wt % in the composition of substances.

22. The fishing lure according to claim 21, wherein the protein is gelatine.

23. The fishing lure according to claim 22, wherein the protein is a medium-bloom, preferably high-bloom gelatine, in particular bone gelatine of animal origin.

24. The fishing lure according to claim 21, wherein the polysaccharide is agar, starch or alginate, or a mixture of agar, starch and/or alginate.

25. The fishing lure according to claim 21, wherein the polyhydric alcohol is glycerol.

26. The fishing lure according to claim 21, wherein the composition of substances comprises at least one preservative, which is an antimicrobial substance, wherein the antimicrobial substance is a vegetable tanning agent, preferably tannin and/or an aluminium salt, preferably aluminium sodium sulphate.

27. The fishing lure according to claim 26, wherein the weight percentage of the at least one preservative in the composition of substances is between 0.05 wt % and 0.5 wt %.

28. The fishing lure according to claim 21, wherein the melting point of the composition of substances is above 55° C., preferably above 65° C.

29. The fishing lure according to claim 21, wherein the composition of substances is free from substances, which are toxic to fish as verified by a method according to OECD 249:2021 or ISO 21115:2019.

30. The fishing lure according to claim 21, comprising a body containing the composition of substances, wherein the body comprises a core and a shell enclosing the core, wherein the shell has a higher strength compared to the core.

31. The fishing lure according to claim 30, wherein the shell is obtained by cross-linking the protein of the composition of substances by means of at least one enzyme.

32. The fishing lure according to claim 21, wherein the composition of substances comprises at least one enzyme for cross-linking the protein.

33. The fishing lure according to claim 32, wherein the at least one enzyme is transglutaminase.

34. A fabrication method for an aquatic degenerating fishing lure according to claim 21, comprising the following method steps:
preparing the composition of substances according to claim 1;
heating the composition of substances to a temperature within a first temperature range and maintaining the temperature within the first temperature range for a first period of time to homogenize the composition of substances preferably using a stirring means;
cooling the composition of substances to a temperature within a second temperature range;
storing the composition of substances at a temperature within the second temperature range for a second period of time;
heating the composition of substances once or several times to a temperature within the first temperature range;
cooling the composition of substances to a temperature within the second temperature range.

35. The fabrication method according to claim 34, wherein the first temperature range is between 55° C. and 200° C. and/or the second temperature range is between 10° C. and 40° C. and wherein the first time period is between 60 minutes and 600 minutes and the second time period is between 20 hours and 10 days.

36. The fabrication method according to claim 34, comprising
after heating one or more times and after cooling the composition of substances to the temperature within the second temperature range;
introducing at least one cross-linking enzyme, preferably transglutaminase, into the composition of substances using a stirring agent.

37. The fabrication method according to claim 36 comprising:
after introducing the cross-linking enzyme;
storing the composition of substances within the second temperature range for a duration within the first time period;
preferably heating the composition of substances to a temperature within a temperature range between 65° C. and 100° C. and maintaining the temperature for a duration within the first time period;
cooling to a temperature within the second temperature range.

38. The fabrication method according to claim 36, comprising:
producing a body comprising the composition of substances.

39. The fabrication method according to claim 36, comprising:
producing a body comprising the composition of substances;
immersing the body in a mixture containing at least one cross-linking enzyme, preferably transglutaminase, for a period between 30 minutes and 120 minutes;
after removal from the mixture
storing the body, preferably in air, at a temperature within the second temperature range and for a duration within the second time period.

40. The fabrication method according to claim 38, comprising:
packaging the body using a package which is sealed airtight, preferably gas-tight.
